(19) United States
(12) Patent Application Publication
(10) Pub. No.: US 2012/0070766 A1
(43) Pub. Date: Mar. 22, 2012

(54) LAMINAR FLOW FUEL CELL INCORPORATING CONCENTRATED LIQUID OXIDANT

(75) Inventor: William Braff, Cambridge, MA (US)

(73) Assignee: Massachusetts Institute of Technology, Cambridge, MA (US)

(21) Appl. No.: 12/886,637

(22) Filed: Sep. 21, 2010

(51) Int. Cl. H01M 8/00

(52) U.S. Cl. 429/498

(57) ABSTRACT

Electrochemical cell system. The system includes a low Reynolds number microfluidic channel including spaced apart anode and cathode forming sides thereof. A fuel channel introduces a liquid fuel into the microfluidic channel for laminar flow along the anode and an oxidant channel introduces a concentrated liquid oxidant into the microfluidic channel for laminar flow along the cathode. An electrolyte channel introduces a liquid electrolyte into the microfluidic channel for laminar flow between the fuel and oxidant flows. Electrodes are connected to the anode and cathode for connection to an external load. In another embodiment, the anode is porous and a gaseous fuel such as hydrogen diffuses through the anode into the interior of the microfluidic channel.

### BACKGROUND OF THE INVENTION

This invention relates to electrochemical cells and more particularly to a hydrogen-halogen laminar flow electrochemical cell that produces scalable, reversible and highly efficient electrochemical energy conversion.

Despite significant advances in both portable and stationary electrochemical energy conversion, the demand for systems with ever greater energy and power densities continues to be unmet. Proton exchange membrane (PEM) based fuel cells have for some time been known to achieve high energy densities in specialized applications, however the inherently unfavorable reaction kinetics of the oxygen reduction reaction occurring at the cathode of such systems has limited their overall efficiency and relegated them to a fairly narrow window of applications. In addition, proton exchange membranes require very precise humidification control to maintain their performance, thereby increasing system weight, cost, and complexity. Solid oxide fuel cells (SOFC) avoid these particular challenges, but their high operating temperatures make them impractical for a wide range of applications.

One proposed solution to this problem has been the laminar flow fuel cell, (LFFC) which replaces the membrane with a liquid electrolyte flowing in a low Reynolds number channel. [1-17] The numbers in brackets refer to references cited herein. The contents of all these references are incorporated herein by reference. By eliminating the membrane, such systems avoid the challenges associated with membrane transport. However, these systems have trouble attaining even modest operating currents, so power densities tend to be inferior to that of traditional PEM systems. As a result, these systems have for the most part been relegated to analytical tools rather than actual energy conversion devices.

### SUMMARY OF THE INVENTION

In one aspect, the electrochemical cell system of the invention includes a low Reynolds number microfluidic channel including spaced apart anode and cathode forming sides thereof. A fuel channel introduces a liquid fuel into the microfluidic channel for laminar flow along the anode. An oxidant channel introduces a concentrated liquid oxidant into the microfluidic channel for laminar flow along the cathode and an electrolyte channel introduces a liquid electrolyte into the microfluidic channel for laminar flow between the fuel and oxidant flows. The anode and cathode are fabricated from materials that exhibit desirable properties as fuel oxidation and oxidant reduction electrocatalysts respectively, such as platinum, palladium, or ruthenium. Electrodes are connected to the anode and cathode for connection to an external load. In a preferred embodiment, the concentrated liquid oxidant is a halogen such as bromine. Suitable electrolytes in this embodiment include hydrobromic acid, sulfuric acid, and potassium hydroxide.

In another aspect, the invention is an electrochemical cell system including a low Reynolds number microfluidic channel including spaced apart anode and cathode forming sides thereof, the anode being permeable to gas, but only minimally permeable to liquid. Means for flowing a gaseous fuel through the porous anode is provided for passage to the surface of the anode facing the electrolyte. An oxidant channel introduces a concentrated liquid oxidant into the microfluidic channel for laminar flow along the cathode. An electrolyte channel introduces a liquid electrolyte into the microfluidic channel for laminar flow between the anode and the oxidant flow. Current collectors are connected to the anode and cathode for connection to an external load. In an embodiment, an array of a plurality of anodes and cathodes are spaced apart from each other along the length of the channel.

In a third aspect, the invention is an electrochemical cell including a low Reynolds number microfluidic channel including spaced apart anode and cathode forming sides thereof, the cathode being permeable to gas, but only minimally permeable to liquid. An inlet channel introduces a liquid halide electrolyte such as hydrobromic acid into the microfludic channel along the anode. Current collectors are connected to the anode and cathode for connection to an external power supply.

In a fourth aspect, the system described in the second aspect is also used as described in the third aspect.

### BRIEF DESCRIPTION OF THE DRAWINGS

FIGS. 1a and 1b are schematic illustrations of two concentrated liquid oxidant laminar flow fuel cells according to an embodiment of the invention.

FIGS. 2a, b and c are schematic illustrations of embodiments for scaling up the invention.

FIGS. 3a and 3b are schematic illustrations of an implementation of a scaled-up system.

FIG. 4 is a schematic illustration of an embodiment of the invention along with the governing equations for a two-dimensional numerical model.

FIG. 5 is a graphical representation of predicted bromine concentration in a hydrogen-bromine laminar flow fuel cell.

FIG. 6 is a graph of cell voltage versus current density illustrating predicted performance of a hydrogen-bromine laminar flow fuel cell.

FIG. 7 is a schematic illustration of a fuel cell cathode according to an embodiment of the invention.

FIG. 8 is a perspective view of an embodiment of the invention.

FIG. 9 is a schematic illustration of another embodiment of the invention.

### DESCRIPTION OF THE PREFERRED EMBODIMENT

The invention comprises an electrochemical cell with a cathode and anode on either side of a microfluidic channel. The channel is preferably of a height between 100 and 500 microns, and optionally between a height of 50 microns and 1 millimeter. Several smaller channels lead into this channel, so that fuel, oxidant, and electrolyte flow can be controlled. On the anode side, fuel is provided either in liquid form via one of these smaller channels or in gaseous form by making the anode out of a porous material that allows gaseous fuel to diffuse through and reach the surface of the anode facing the electrolyte. On the cathode, a liquid oxidant such as bromine is provided via one of the smaller channels leading into the larger channel. The non-turbulent nature of the fluid flow within the device ensures that the mixing zones between fuel, electrolyte, and oxidant can be determined analytically, and kept small enough to eliminate any efficiency loss due to crossover of reactants.

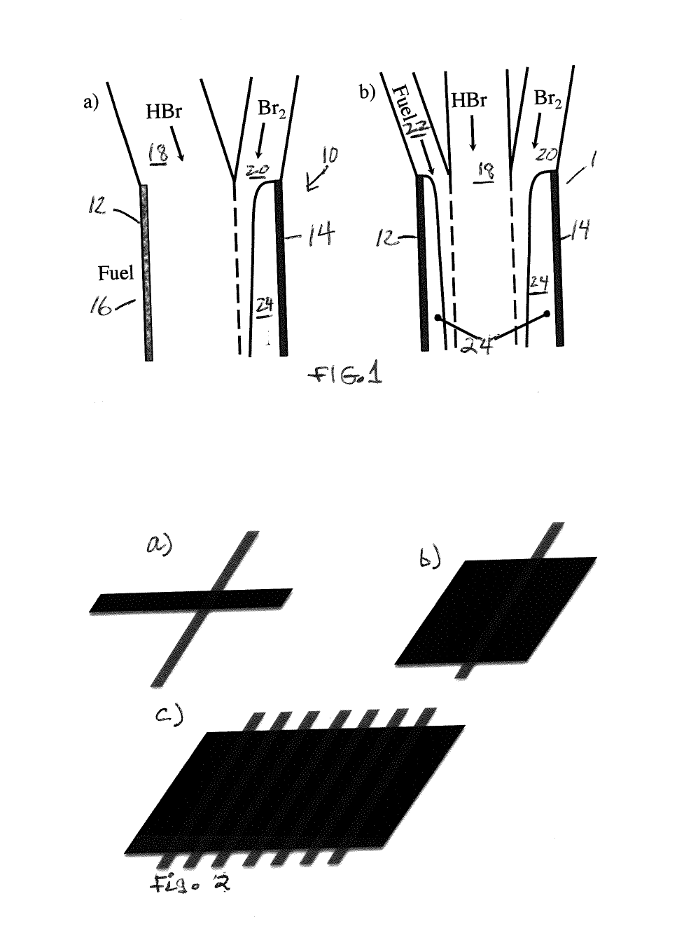

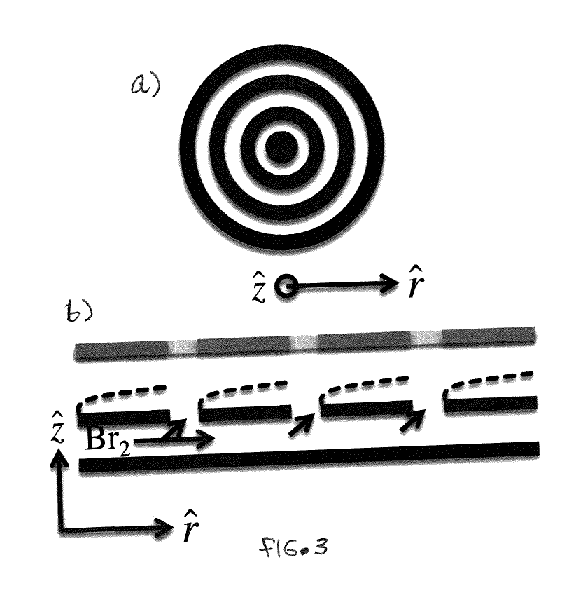

With reference now to FIGS. 1a and 1b, in FIG. 1a an electrochemical cell 10 includes a porous anode 12 and a cathode 14. A fuel 16 such as hydrogen is flowed along the anode 12 and will diffuse to the surface of the anode facing the electrolyte. A smaller channel 18 introduces an electrolyte such as hydrobromic acid, sulfuric acid, or potassium hydroxide, and a smaller channel 20 serves to introduce a concentrated liquid oxidant such as bromine, either in concentrated faun, in water, or mixed with the electrolyte. The electrolyte is diluted in water to a concentration between 0.1 and 10 molar.

With respect to FIG. 1b, the anode 12 is non-porous. In this embodiment a fuel passage 22 serves to introduce fuel into the cell 10. It should be noted that in FIG. 1b, a liquid fuel such as formic acid, methanol, ethanol or hydrazine is suitable and may be supplied to flow along the anode 12. Depletion zones 24 will be determined by the operating current of the cell as will be discussed below and can be analyzed to determine the limiting current of the cell. The non-turbulent nature of the fluid flow within the cell 10 ensures that the mixing zones between fuel, electrolyte, and oxidant can be determined analytically and kept small enough to eliminate any efficiency loss due to crossover of reactants.

Because non-turbulent flows can be described by relatively simple forms of the Navier-Stokes equation, and all the products and reactants (apart from hydrogen, which is kept distinct from the channel) are liquids, steady state modeling and optimization of this cell is possible without resorting to two phase flow calculations.

One additional feature of the device shown in FIG. 1a is that as the system approaches peak power, the edge of the depletion region 24 will approach the oxidant electrolyte interface, and the bromine concentration in the effluent will asymptotically approach zero, resulting in high fuel utilization. In such a configuration, no recirculation of oxidant would be necessary, and recovery of bromine from the hydrobromic acid can be done electrolytically by reversing the flow of direction to the system and supplying current. Likewise, because no product gases or liquids are produced at the anode, there is no need to recirculate or humidify the hydrogen gas being supplied to the system. A more detailed description of the electrochemistry of the system is provided below.

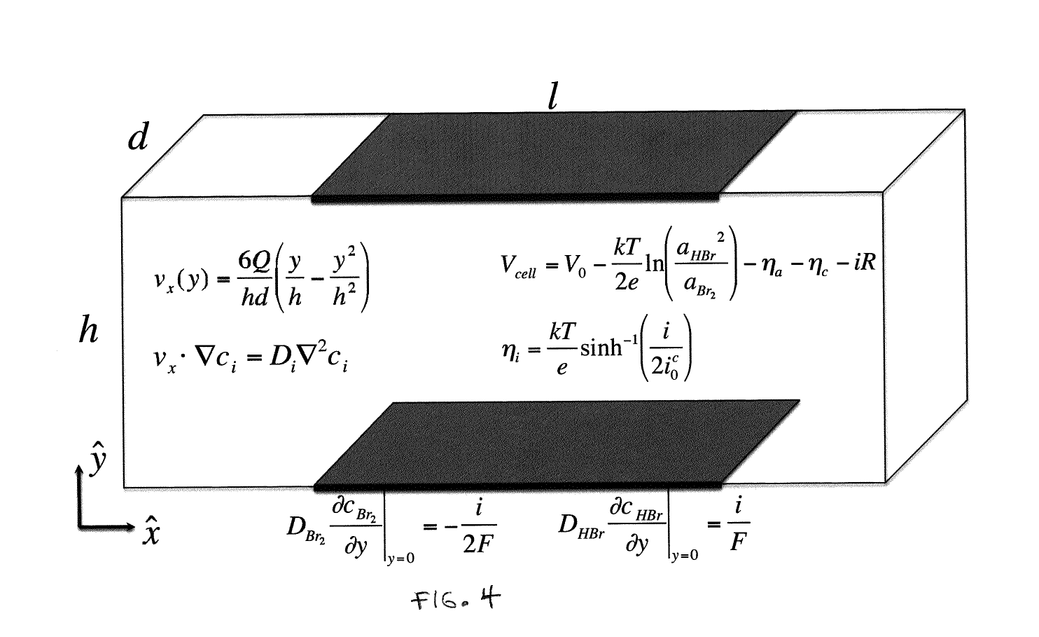

The fluid mechanics of the system are such that the system can be easily scaled in one dimension without affecting the underlying physics. In order to fabricate large scale systems, however, two dimensional scaling will be necessary. In order to achieve this, we implement sequential injections of oxidant into the system using an array of electrodes as shown in FIGS. 2a, b and c. Such a system could be constructed in a disc-like geometry as shown in FIG. 3a. As shown in FIG. 3b, oxidant and electrolyte may be injected at the center of the cell and flow outwardly. A lower, oxidant-only channel is used to provide periodic injections of oxidant to the cathode in order to replenish the depletion zone. The disc-like geometry in FIG. 3a is able to accommodate the increased flow.

In order to evaluate the capabilities of a system based on this technology, a simple model for the performance of a hydrogen-bromine laminar flow fuel cell, as illustrated in FIG. 1a is presented here. For a first order estimation, we will examine a one dimensional system with planar electrodes. We will assume that the equilibrium voltage is described by the Nernst equation, and that the reaction kinetics are accurately described by the Butler-Volmer equation with symmetric (α=½) reactions. Concentration polarizations will be introduced based on our results shown below.

In general, the fuel cell voltage can be expressed as

V(I)=φ_{c}−φₐ−IRₑₗ=V_{eq}−η_{c}−ηₐ−IRₑₗ

and the electrochemical half cell reactions for this system are:

anode: H₂→2H⁺+2e⁻

cathode: Br₂+2e⁻+2H⁺→2HBr

net: H₂+Br₂→2HBr.

It is worth noting that because all the reactants and products (excluding the hydrogen gas, which has a well defined interface with the rest of the system) are liquid, there will be no two-phase flow, and it is reasonable to assume locally homogeneous concentrations. The equilibrium voltage V_{eq} can be determined from the Nernst equation using existing thermodynamic data at reference conditions of 1 atm, 298.15 K, and unit molality. [18] The activity coefficient for HBr over a broad range of molalities is ˜0.8, so an ideal dilute solution theory for the liquid reactants is valid. Likewise, the hydrogen can be treated as an ideal gas. In this case, the Nernst equation reads:

$${V}_{eq} = 1.087 + \frac{RT}{2 F} ln ( \frac{{m}_{{Br}_{2}} {P}_{{H}_{2}}}{{m}_{HBr}^{2}} )$$

Under a typical operating condition of m_{Br2}=3 mol/kg and m_{HBr}, =2 mol/kg with everything else at standard conditions, Veq=1.083 V.

To determine the electrolyte resistance, we choose a characteristic channel width of 500 μm, and employ existing data to determine the specific resistance of the cell to be Rel=89 mΩ·cm² for 2 molar hydrobromic acid. [19]

To complete the model, we need to describe the reaction kinetics at both the anode and cathode. In general, the Butler-Volmer equation can be written as

I=Iᵢ⁰(e^{(1-α)Fη}^{ᵢ}^{/RT}−e^{-αFη}^{ᵢ}^{/RT})

Where ηᵢ is the activation overpotential and Iᵢ⁰ is the exchange current density at either the anode or cathode. If we make the symmetric reaction assumption, Butler-Volmer can be simplified and written as

$${η}_{i} = \frac{RT}{F} {sinh}^{- 1} ( \frac{I}{2 {I}_{i}^{0}} )$$

Where

Iᵢ⁰=Kᵢ⁰\sqrt{a_{reactants}a_{products}}

Although concentrated solution theory would be necessary to obtain optimal accuracy, we are justified in approximating the system as ideally dilute because the activity coefficients for all components in the system are close to unity. Previous studies have determined the anode and cathode reactions in the presence of platinum to have exchange current densities of order by Kₐ⁰˜1 mA/cm2 and K_{c}⁰˜50 mA/cm2 respectively. [8, 18] If we further observe that the anode in this system will be porous with a high surface area catalyst, we are justified in estimating a 100 to 1 ratio for the anode surface area to electrolyte surface area. [20]

These elements can be combined to determine a voltage current relationship. As a final correction, we now include the effects of concentration polarization on the equilibrium voltage, again assuming ideal solution behavior of the reaction kinetics. We know that the bromine concentration mBr2 at the electrode surface can be written in terms of the bulk concentration as

$${m}_{{Br}_{2}} \approx {\overline{m}}_{{Br}_{2}} ( 1 - \frac{I}{{I}_{lim}} )$$

so we can easily include concentration polarizations in the Nernst equation. There will also be an enrichment effect on the hydrobromic acid, which can be written

$${m}_{HBr} \approx {\overline{m}}_{HBr} + 2 {\overline{m}}_{{Br}_{2}} \frac{I}{{I}_{lim}} .$$

For simplicity, we consider the case where Pe˜L/H. Because of the weak (⅓ power) dependence on limiting current density that was derived below, variations from this condition will not strongly affect limiting current. The limiting current density can then be written

$${I}_{lim} ∼ \frac{2 {m}_{{Br}_{2}} FD}{w} ,$$

where w=50 μm is the channel width, D˜10⁵ cm² is the diffusivity of bromine in an aqueous solution, and ρ=3.10×10−3 kg/cm³ is the density of bromine. For 3 molal bromine and 2 molal hydrobromic acid, we obtain a limiting current under our typical operating conditions of Ilim˜7.179 A/cm². When all of these effects are taken into account, we obtain power and current characteristics (neglecting external contact losses) with a peak power density of over 5 W/cm² occurring at 6.895 A/cm². At 1.5 A/cm², a typical high current operating point, the cell produces 1.383 W/cm² at an efficiency of 84.9%. These efficiencies rival those of batteries while still maintaining the energy density advantages that fuel cells typically exhibit. It worth mentioning that these results do not consider overall depletion of the oxidant in the bulk of the channel, which is significant at high fuel utilization.

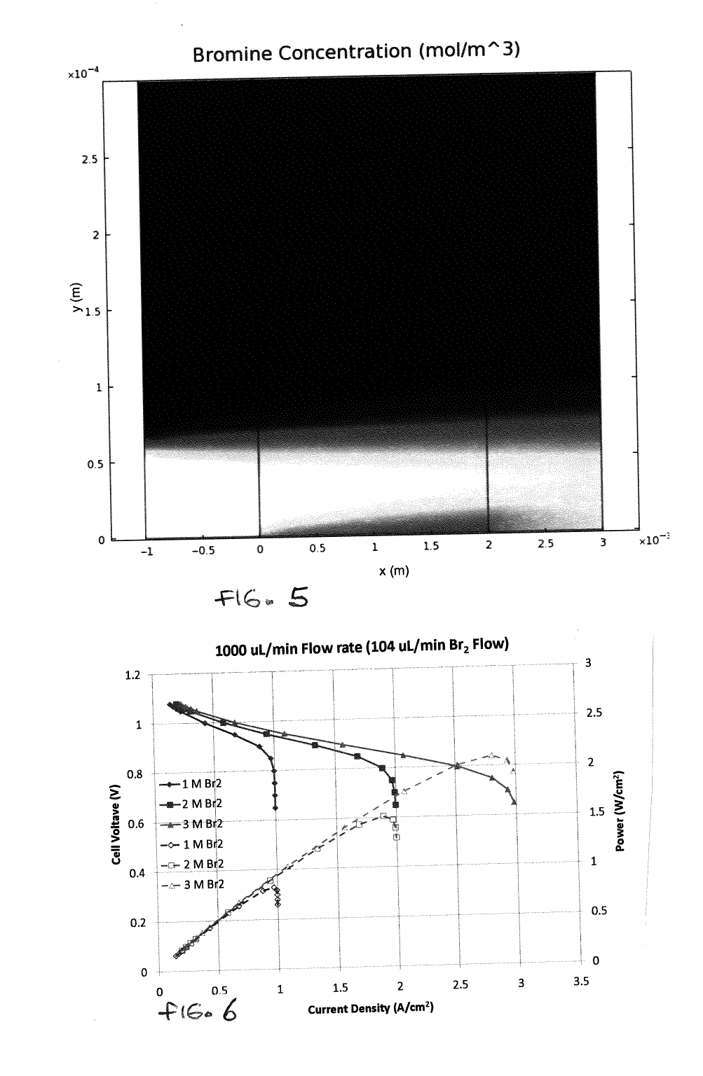

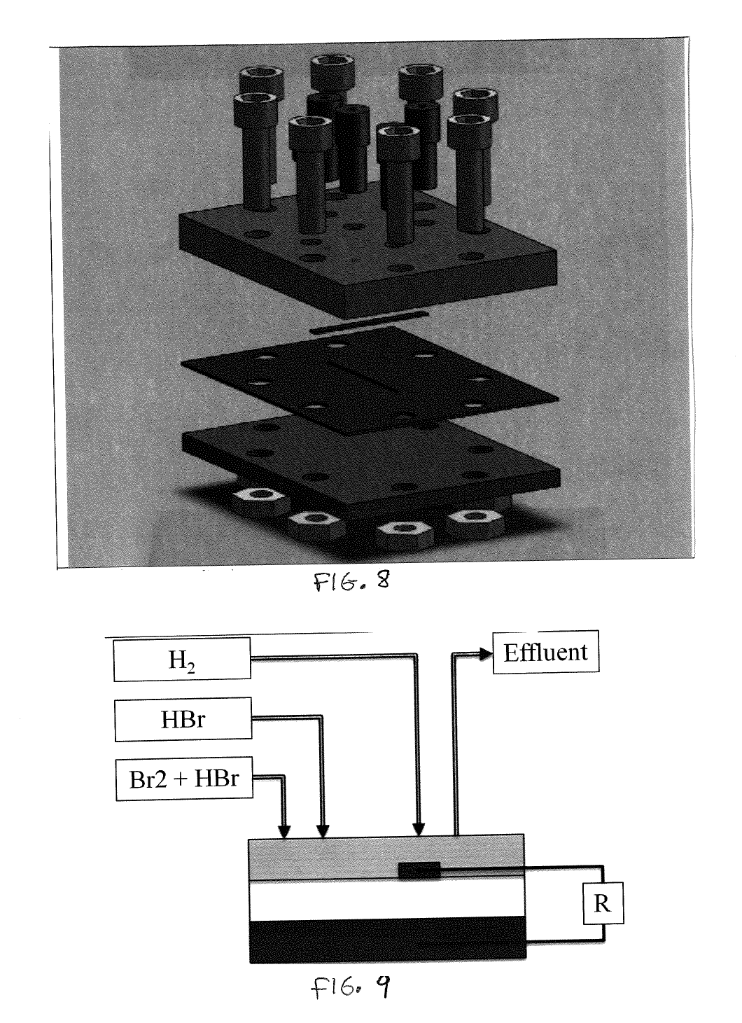

In order to further verify the predicted results, a two-dimensional model of the system was implemented in COMSOL Multiphysics, a finite element software package. Unlike the 1D model, a finite flow rate is assumed in this case, and the polarization losses due to depletion of the oxidant are considered. The model geometry is based on the system shown in FIG. 8, and the governing equations are shown in FIG. 4. The results obtained are qualitatively consistent with the one-dimensional boundary layer model shown in FIG. 7. As expected, the diffusion and depletion zones both grow gradually over the length of the electrode, so that the bromine concentration at the outlet of the cell is significantly lower than at the inlet of the cell. A representative solution is shown in FIG. 5.

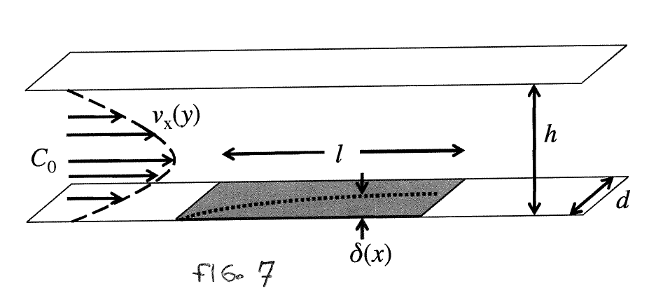

By running the model under a number of operating conditions, voltage-current relationships can be obtained. FIG. 6 shows predicted performance over a range of concentrations at a fixed oxidant flow rate. Under these conditions, a maximum power density of over 2 W/cm2 is predicted.

Understanding the characteristics of the depletion region above the electrode in a laminar flow cell as shown in FIG. 7 is critical to estimating the performance characteristics of this type of system. For low Reynolds number flow in a channel with height and depth h<<d and flow rate Q, the unidirectional flow profile can be described as

$${v}_{x} ( y ) = \frac{6 Q}{hd} ( \frac{y}{h} - \frac{{y}^{2}}{{h}^{2}} ) .$$

We wish to characterize the oxidant concentration profile above an electrode operating at constant current i for the case where the inlet concentration is C₀ and the oxidant diffusion constant is D. The governing advection diffusion equation for this system is

$$\frac{6 Q}{hd} ( \frac{y}{h} - \frac{{y}^{2}}{{h}^{2}} ) \frac{\partial C}{\partial x} = D \frac{{\partial }^{2} C}{\partial {y}^{2}}$$

If we treat the concentration boundary layer as thin, the boundary conditions on this system can be written:

$$C ( x = 0 , y ) = {C}_{0}$$

$$C ( x , y \to \frac{h}{2} ) = {C}_{0}$$

$$D \frac{\partial C}{\partial y} {\vert}_{y = 0} = - \frac{i}{2 F}$$

For convenience, we introduce the following dimensionless quantities:

$$\begin{matrix}\tilde{x} = \frac{x}{h} & θ = \frac{{C}_{0} - C}{{C}_{0}} \\ \tilde{y} = \frac{y}{h} & Pe = \frac{2 Q}{dD} \\ {\tilde{v}}_{x} = \frac{hd}{Q} {v}_{x} & Sh = \frac{h}{2 {C}_{0} DF} i\end{matrix}$$

For thin boundary layers, the quadratic velocity profile in y can be approximated as linear, and the governing equation can be expressed in dimensionless quantities as

$$Pe \frac{\partial θ}{\partial \tilde{x}} = \frac{1}{3 \tilde{y}} \frac{{\partial }^{2} θ}{\partial {\tilde{y}}^{2}}$$

The boundary conditions now read:

$$θ ( \tilde{x} = 0 , \tilde{y} ) = 0$$

$$θ ( \tilde{x} , \tilde{y} \to \frac{1}{2} ) = 0$$

$$\frac{\partial θ}{\partial \tilde{y}} {\vert}_{\tilde{y} = 0} = - Sh$$

For distances sufficiently far from the reaction zone, the concentration will not be affected by the reaction, which means that all of the change in concentration must occur within a layer of some thickness δ. This layer can be determined by considering the dominant balance for the governing equation. Putting the dimensions back in, the boundary layer is of thickness:

$$\frac{h}{x} Pe ∼ \frac{{h}^{3}}{{δ}^{3}}$$

$$δ ∼ {( \frac{{h}^{2} x}{Pe} )}^{1 / 3}$$

This result shows us that as the depletion region develops along the length of the electrode, the solute will have to diffuse further to reach the electrode. This will result in a reduction in the attainable current, and will ultimately allow us to predict a limiting current. We can calculate this limiting current by observing that the maximum oxidant flux occurs when the oxidant concentration at the electrode reaches zero. For a purely diffusion based system, the limiting current can be written as

$${i}_{0} = \frac{2 {C}_{0} DF}{h} .$$

Note that for the diffusion only system, the dimensionless Sherwood number Sh is equal to one. In the proposed system, then the limiting current can be determined by

iₗᵢₘ=i₀∫₀^{\tilde{x}}Shd\tilde{x}

$$Sh ∼ \frac{1}{δ} ∼ {( \frac{Pe}{{h}^{2} x} )}^{1 / 3} ,$$

We can see from our boundary condition that so our limiting current is

$${i}_{lim} = {{i}_{0} ( \frac{h}{l} Pe )}^{1 / 3}$$

This result demonstrates that in order to avoid being limited by the depletion zone, flow velocity must be sufficiently high such that Pe˜l/h.

In order for the proposed system to exhibit the necessary fluid flow and transport properties for optimal performance, the fluid flow must be of a laminar nature. For this to be the case, the Reynolds number of the system must be well below 2100. For a fluid channel of height and depth h<<d, and a fluid of viscosity, μ and density ρ with a volumetric flow rate of Q, the Reynolds number for the system can be expressed as

$$Re = \frac{ρ Q}{μ d} .$$

In a preferred configuration, d=381 μm, ρ=1000 kg/m³, ρ=0.001 Pa s, and Q=1 mL/min. In this system, the Reynolds number is approximately 8, which is well within the laminar flow regime. Although the viscosity and density of the fluid will tend not to vary widely, the flow rate and channel depth can be varied freely within this constraint. For example, the flow rate could be increased by a factor often to facilitate transport of oxidant to the cathode without introducing any turbulence into the velocity profile in the channel.

An additional transport requirement for this system is that the diffusive mixing zone at the interface between the streams must not reach either the cathode or anode. As discussed above, the diffusive mixing zone Scan be estimated to have thickness

$$δ \approx {( \frac{{xh}^{2}}{Pe} )}^{1 / 3}$$

where Pe is the Peclet number of the system, expressed as

$$Pe = \frac{Q}{dD} .$$

In the same preferred configuration, D≈10⁻⁵ cm²/s, so Pe≈800. In that case, in order for the mixing zone not to exceed half the channel width, the electrode length must be less than 3.8 cm.

### Example 1

In a preferred embodiment, a 381 μm layer of 75 durometer Viton sheet is sandwiched between a 3 mm Hastelloy-C cathode current collector and a 10 mm Polyvinylidene Fluoride (PVDF) porting plate. A channel 2 mm wide is cut into the Viton layer to form the fluid channel. The cathode current collector is prepared by applying a 1 mg/cm² loading of platinum black to the active area underneath the channel to serve as the cathode catalyst. The PVDF porting plate is prepared by milling a 2 mm wide, 24 mm long, 315 μm deep pocket into the underside of the plate, perpendicular to the fluid channel. This pocket is filled with a piece of porous gas diffusion media of the same size that serves as the anode current collector. The face of the diffusion media facing the fluid channel is coated with a 2 μm microporous layer consisting of high surface area carbon and polytetrafluoroethylene (PTFE), followed by a layer of 1 mg/cm² platinum black. Three ports for oxidant, electrolyte, and effluent are drilled and tapped into the PVDF porting plate along the length of the fluid channel, and two gas ports are drilled and tapped into the plate along the length of the gas diffusion media channel. In order to facilitate sealing but maintain chemical compatibility, a compression fitting employing an ethylene-tetrafluoroethylene (ETFE) ferrule is used. These components are shown in FIG. 8. Copper wires connect the cathode current collector to an external electronic load initially programmed to maintain zero current.

Separately, two aqueous solutions are prepared in glass syringes: one is a mixture of one molar hydrobromic acid and one molar bromine, which will serve as the oxidant stream, and one is one molar hydrobromic acid, which will serve as the electrolyte. The syringes are loaded into syringe pumps. The electrolyte solution is fed via a 1/16″ outer diameter PTFE tube into the electrolyte port on the PVDF plate at a rate of 0.8 mL per minute, and it is collected out of the effluent port at the far end of the channel. Hydrogen gas at a pressure of 10 kPa is fed into one of the gas ports and allowed to flow through the second port for two minutes to purge out any trapped air, and then the second port is shut. The strongly hydrophobic nature of the microporous layer on the anode current collector ensures that fluids do not enter the porous diffusion media. Once the exhaust port is shut, the oxidant solution is fed into the oxidant port at a flow rate of 0.2 mL per minute via a second 1/16″ outer diameter PTFE tube. The addition of the oxidant completes the electrochemical circuit, and a voltage of approximately one volt is observed across the electronic load. The external electronic load is then programmed to allow current to pass, and the system produces electricity. A schematic of this configuration is shown in FIG. 9.

### Example 2

In a second preferred embodiment, the cell is constructed in a similar fashion, however the PVDF porting plate is replaced with a Hastelloy-C porting plate that now serves as the anode current collector, and the porous gas diffusion media and its channel and gas ports are eliminated. A layer of 1 mg/cm² platinum black is applied to the porting plate in the active region above the microfluidic channel to serve as the anode catalyst. Also, an additional port for fuel is added to the porting plate after the electrolyte port but upstream of the active region along the length of the fluid channel. The copper wire that previously connected the porous anode current collector to the external load now connects the Hastelloy porting plate to the external load. In place of gaseous hydrogen fuel, an aqueous solution of one molar formic acid is prepared and loaded into a third glass syringe in a syringe pump. The electrolyte is pumped at a rate of 0.6 mL per minute, while the fuel and oxidant streams are both pumped at a rate of 0.2 mL per minute. The external load is operated in the same manner as in example 1.

It is recognized that modifications and variations of the invention disclosed herein will be apparent to those of ordinary skill in the art and it is intended that all such modifications and variations be included in the claims.

### REFERENCES

[1] E. R. Choban, P. Waszczuk, P. J. A. Kenis, T. Tzedakis, S. K. Yoon, and C. Kane, “Microfluid device and synthetic methods,” U.S. Pat. No. 7,273,541, 2007.
[2] J. L. Cohen, D. J. Volpe, and H. D. Abruna, “Duel electrolyte membraneless microchannel fuel cells,” U.S. Patent Application 2006/0 228 622, 2006.
[3] L. Cohen, D. J. Volpe, D. A. Westly, A. Pechenik, and H. D. Abruna, “Planar membraneless microchannel fuel cell,” U.S. Pat. No. 7,435,503, 2008.
[4] S. Hasegawa and H. Watanabe, “Cell and power generation method,” U.S. Patent Application 2007/0 181 418, 2007.
[5] P. J. A. Kenis, A. Wieckowski, and E. R. Choban, “Membraneless electrochemical cell and microfluidic device without ph constraint,” U.S. Pat. No. 7,635,530, 2009.
[6] E. Kjeang, D. Sinton, and N. Djilali, “A microfluidic fuel cell with flow—through porous electrodes,” U.S. Patent Application 2009/0 092 882, 2009.
[7] L. J. Markoski, J. Moore, and J. Lyding, “Electrochemical cells comprising laminar flow induced dynamic conducting interfaces, electronic devices comprising such cells, and methods employing same,” U.S. Pat. No. 6,713,206, 2004.
[8] L. J. Markoski, D. Natarajan, and A. Primak, “Fuel cell apparatus and method of fabrication,” U.S. Patent Application 2005/0 202 305, 2005.
[9] L. J. Markoski, D. Natarajan, and A. Primak, “Electrochemical cells,” U.S. Patent Application 2006/0 088 744, 2006.
[10] L. J. Markoski, D. Natarajan, and A. Primak, “System for flexible in situ control of water in fuel cells,” U.S. Patent Application 2007/0 190 393, 2007.
[11] L. J. Markoski, P. J. A. Kenis, and E. R. Choban, “Fuel cells comprising laminar flow induced dynamic conducting interace, electronic devices comprising such cells, and methods employing same,” U.S. Pat. No. 7,252,898, 2007.
[12] L. J. Markoski, D. Natarajan, and A. Primak, “Microfluidic fuel cells,” U.S. Patent Application 2008/0 248 343, 2008.
[13] L. J. Markoski, A. Primak, and D. Natarajan, “Microfluidic fuel cell electrode system,” U.S. Patent Application 2009/0 035 644, 2009.
[14] L. J. Ohlsen and J. C. Mallari, “Fuel cell systems having internal multistream laminar flow,” U.S. Patent Application 2004/0 058 217, 2004.
[15] W. E. Pelton and P. J. A. Kenis, “System of distributed electrochemical cells integrated with microelectronic structures,” U.S. Patent Application 2007/0 020 496, 2007.
[16] W. E. Pelton and P. J. A. Kenis, “Distributed electrochemical cells integrated with microelectronic structures,” U.S. Patent Application 2007/0 026 266, 2007.
[17] K. S. Salloum and J. Posner, “Counter-flow membraneless fuel cell,” U.S. Patent Application 2010/0 112 391, 2010.
[18] S. Bratsch, “Standard electrode potentials and temperature coefficients in water at 298.15 K,” J. Phys Chem Ref Data, Vol. 18, no. 1, pp. 1-21. 1989.
[19] D. R. Lide, CRC handbook of Chemistry and Physics, 75^{th} ed. Cleveland, Ohio: CRC Press, 2004.
[20] R. Savinell and S. Fritts, “Theoretical performance of a hydrogen bromine rechargeable SPE fuel-cell,” J Power Sources, vol. 22, no. 3-4, pp. 423-440, 1988.

What is claimed is:

1. Electrochemical cell system comprising:
a channel including spaced apart anode and cathode forming sides thereof;
a fuel channel for introducing a liquid fuel into the micro fluidic channel for laminar flow along the anode;
an oxidant channel for introducing a concentrated liquid oxidant into the microfluidic channel for laminar flow along the cathode;
an electrolyte channel for introducing a liquid electrolyte into the microfluidic channel for laminar flow between the fuel and oxidant flows; and
current collectors connected to the anode and cathode for connection to an external load.

2. The system of claim 1 wherein the concentrated liquid oxidant is a halogen.

3. The system of claim 2 wherein the halogen is bromine.

4. The system of claim 3 wherein the electrolyte is hydrobromic acid, sulfuric acid, potassium hydroxide, or similar liquid electrolyte.

5. The system of claim 4 wherein the cathode and anode current collectors are made from Hastelloy, tantalum, niobium, or other halogen compatible, electrically conductive material.

6. Electrochemical cell system comprising:
a channel including spaced apart anode and cathode forming sides thereof, the anode being permeable to gas, but only minimally permeable to liquid;
means for flowing a gaseous fuel such as hydrogen along the outside of the porous anode for passage to the surface between the anode and the microfluidic channel;
an oxidant channel for introducing a concentrated liquid oxidant into the microfluidic channel for laminar flow along the cathode;
an electrolyte channel for introducing a liquid electrolyte into the microfluidic channel for laminar flow between the anode and the oxidant flow; and
current collectors connected to the anode and cathode for connection to an external load.

7. The system of claim 6 wherein the concentrated liquid oxidant is a halogen.

8. The system of claim 6 wherein the halogen is bromine.

9. The system of claim 6 wherein the electrolyte is hydrobromic acid, sulfuric acid, potassium hydroxide, or similar liquid electrolyte.

10. The system of claim 9 wherein the cathode current collector is made from Hastelloy, tantalum, niobium, or other halogen compatible, electrically conductive material.

11. The system of claim 9 wherein the anode current collector is made from carbon fiber paper with a microporous layer of carbon and PTFE onto which the anode is applied.

12. The system of claim 9 wherein the anode current collector is sealed against the channel by means of a porting plate made of PVDF, PTFE, or other halogen compatible, electrically insulating material.

13. The system of claim 9 wherein the external load is replaced with an external power supply, and wherein the oxidant channel, electrolyte channel, and means for flowing a gaseous fuel are now used to collect the reaction products.

14. The system of claim 13 wherein an external load and an external power supply can be switched in and out of the circuit, so that the system may be used as a rechargeable energy source.

15. The system of claim 1, claim 2, claim 9, claim 13, or claim 14 wherein the microfluidic channels are made in a piece of viton, PTFE, PFA, or other halogen compatible, electrically insulating material. The viton is preferably of thickness 100 to 500 microns, and optionally of thickness 25 to 5000 microns

16. The system of claim 1, claim 2, claim 9, claim 13, or claim 14 including an array of a plurality of anodes spaced apart from the cathode.

17. The system of claim 1, claim 2, claim 9, claim 13, or claim 14 wherein a second, oxidant only layer is placed beneath the cathode, and means is provided to inject fresh oxidant into the microfluidic channel along the surface of the cathode via ports along the length of the channel.

18. The system of claim 1, claim 2, claim 9, claim 13, or claim 14 wherein the anode and cathode consist of a catalyst consisting of platinum, palladium, ruthenium, iridium, or other material known for its desirable catalytic properties or of some combination of these materials.
